(19) United States
(12) Patent Application Publication
(10) Pub. No.: US 2008/0004902 A1
(43) Pub. Date: Jan. 3, 2008

(54) System, method, and device for providing health information

(76) Inventors: Andrew Leong-Fern, Toled, OH (US); Peter Gorman, Sylvania, OH (US); Paul Lasiuk, Chicago, IL (US)

Correspondence Address: BRINKS HOFER GILSON & LIONE, P.O. BOX 10395, CHICAGO, IL, 60610, US

(21) Appl. No.: 11/479,543

(22) Filed: Jun. 30, 2006

(51) Int. Cl. G09B 9/00; G06Q 10/00

(52) U.S. Cl. 705/2; 434/1

(57) ABSTRACT

A method, system and device is disclosed for encouraging behavioral change in users. The method and system may utilize a tool which presents information and topics related to a health condition and illustrates the affects of behavior choices on the maintenance or progression of the health condition. When used with a facilitator, conversation questions, and exercises, the user may explore a health condition, learn what to expect as the condition progresses, and learn how to manage the condition such as mentally and physically.

### BACKGROUND

As time restraints on health care professionals increase, doctors and nurses find that they have less time to spend consulting with patients on topics such as progression and management of their health condition. Patients are increasingly being called upon to make important decisions related to managing and maintaining their health. Health care information is often transmitted to patients in the form of a pamphlet or handout.

Many patients are set in specific behavior patterns when they are diagnosed with a health condition, for example, diabetes, obesity, cancer, depression and etc. Further, patients, their families and friends may have preconceived notions about the health condition which may be true or untrue. It may be difficult for these patients to change their comfortable and familiar behavior patterns, such as their exercise and diet patterns. Current formats by which health information is transmitted, e.g., pamphlets and handouts, may fail to elicit behavior change in patients.

### BRIEF SUMMARY

A method, system and device disclose health-related information through elicited conversation. A facilitator may use conversation questions to guide users through information represented on an experiential learning tool. Exercises may be utilized in combination with the experiential learning tool to engage the user or users in thought-provoking exploration of behavior, attitude, or decisions related to a presented health topic.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a diagram of an exemplary system.

FIG. 2 is a schematic of an exemplary experiential learning tool.

FIG. 3 is a plan view of exemplary cards.

FIG. 4 is a plan view of exemplary cards.

FIG. 5 is a plan view of exemplary cards.

FIG. 6 is a plan view of an exemplary action plan form.

FIG. 7 is a schematic of an exemplary experiential learning tool.

FIG. 8 is a plan view of exemplary cards.

FIG. 9 is a plan view of exemplary cards.

FIG. 10 is a plan view of exemplary cards.

FIG. 11 is a plan view of exemplary media.

FIG. 12 is sketch of a notebook.

FIG. 13 is a sketch of an exemplary experiential learning tool.

### DETAILED DESCRIPTION

A method, system, and device for guiding users through health-related information are disclosed. The method, system and device may promote, for example, learning and behavioral change by presenting health information to users and allowing users to form their own conclusions about how the information is relevant to their lives.

The system for guiding users though health-related information may include a facilitator, a user or group of users, an experiential learning tool (“tool”), and exercises. The tool may be, for example, a map. The method may include the steps of, through a facilitator, guiding a user or users through health topics represented visually, textually, or otherwise by the tool. The system may also include exercises, such as but not limited to, card exercises, blocks, puzzles, physically and digitally interactive media, and other things.

The facilitator may guide users through a conversation about a health condition by asking conversation questions. The questions may be used to arouse curiosity and at the same time serve as a logical, incremental, step-wise guide that enables users to figure out about a complex health topic or issue with their own thinking and insights. Users may tend to get stuck at some point and need a facilitator's explanation of some aspect, or it may become more efficient to “tell” some health related issues. If “telling” does occur, the users may have been aroused by the conversation questions to a state of curious receptivity to absorb an explanation that might otherwise have been meaningless to them. The conversation questions may be decided before the session; but depending on what answers are given, some questions may be thought up extemporaneously.

Health information may be presented to an individual or to a group of users. The users may be patients diagnosed with a health condition, or alternatively, may be friends, family members, coworkers, colleagues, of an individual with a health condition, or may be health care professionals or health educators or others. If the information is presented to a group of users, the users may find it beneficial to share their knowledge and experience about the health condition with the other members of the group. This may strengthen the ability of the users to digest health information by making it personally relevant and/or reducing feelings of isolation.

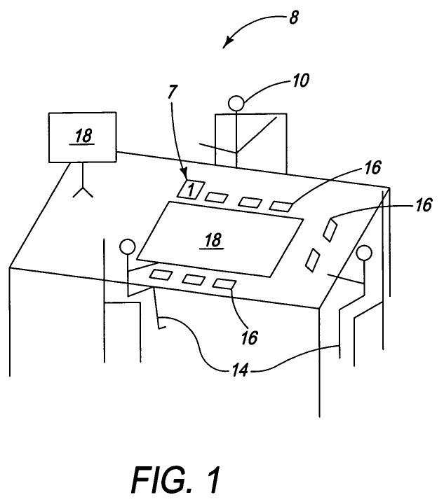

FIG. 1 illustrates an environment of the system. A tool 18 (e.g., a map, computer display, blocks, puzzles, and etc.), questions 7, and facilitator 10 may structure the presentation of health information while creating a flexible environment 8 in which the users 14 gain personally relevant health information. The facilitator 10 may be a health professional, such as a nurse or pharmacist. Alternatively, the facilitator 10 may be a non-health professional or even a programmed computer. The facilitator 10 may not require training and may be one of the users themselves.

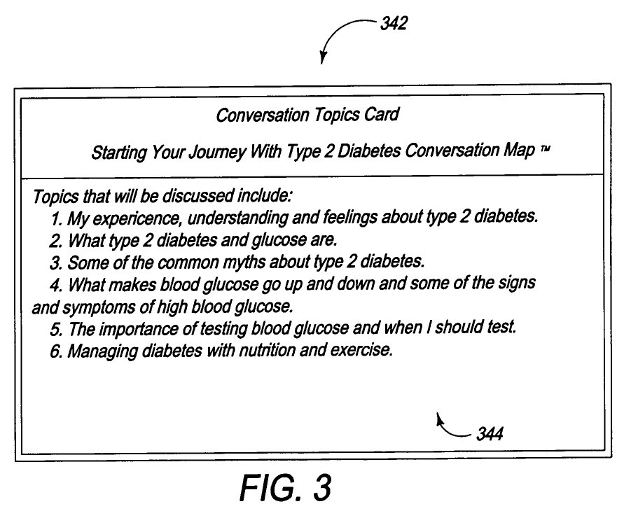

The facilitator's 10 role may be to guide users 14 through health topics utilizing a tool 18. The facilitator 10 may use structured conversation questions 7 and exercises, which may be cards 16 (e.g., FIGS. 3-6, 8-10) to ensure that learning goals are achieved. The learning goals may be different for each user or group of users and may be unique on each use based on what the users 14 bring to the conversation.

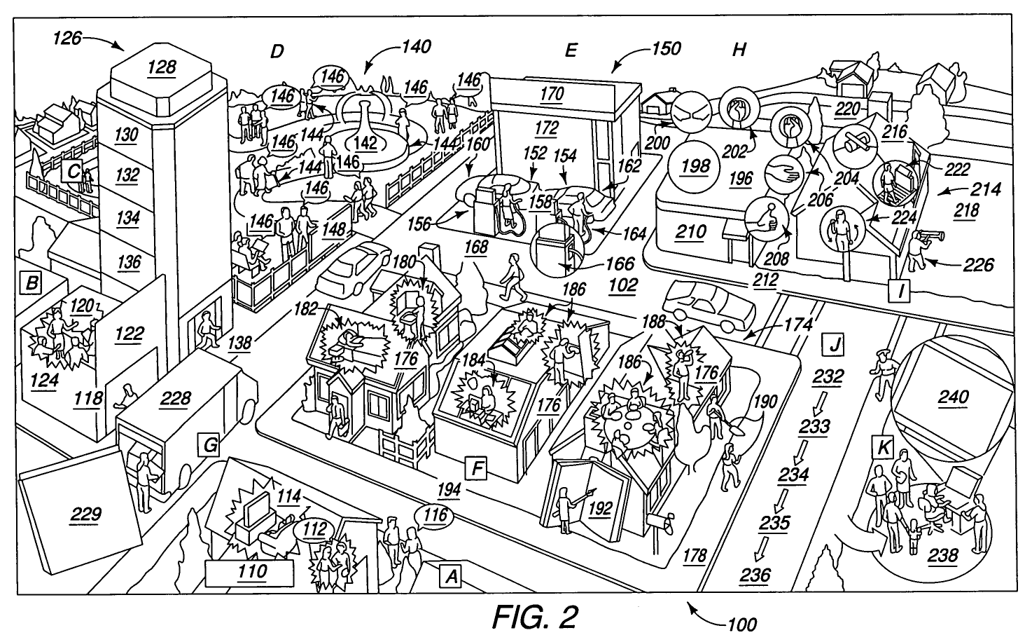

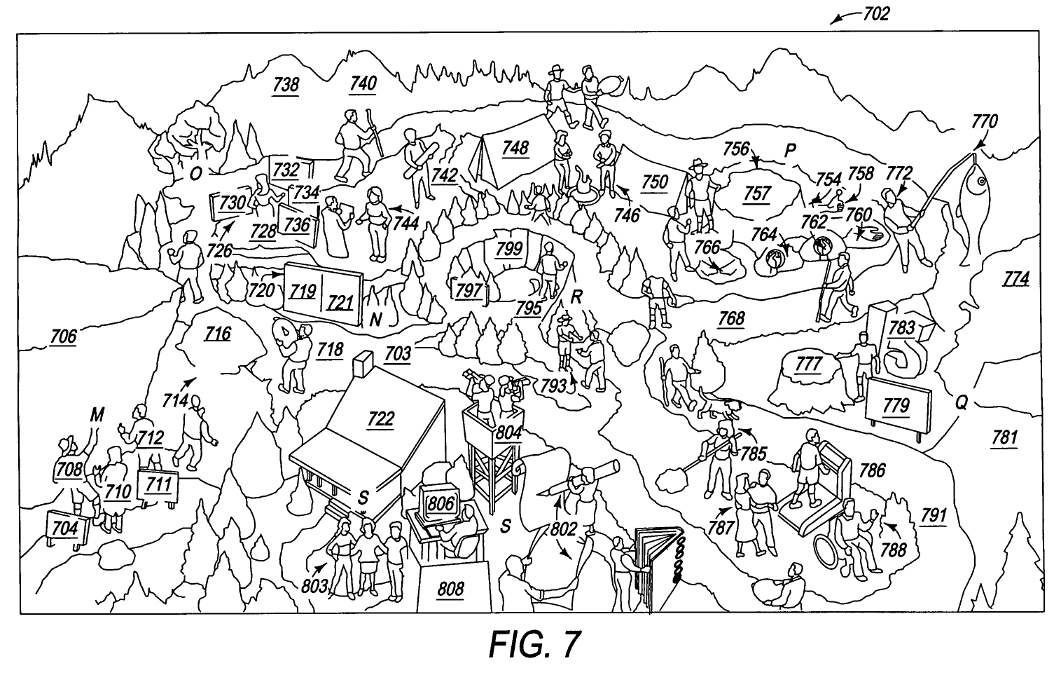

Health information may be represented to the users 14 by a tool 18, for example, a map (e.g., FIGS. 2 and 7). As used herein, representations may be metaphorical, pictorial, or textual. The representation may be a metaphor for the various health topics related to a health condition. For example, but not limited to, a map guiding users through health topics related to managing diabetes.

The tool 18 (e.g., FIGS. 2 and 7) may create an interesting and engaging focal point for communicating health information. The tool 18 may further help the users 14 recall the information that they learn. For example, the users 14 may be provided with a personal copy of the tool 18 to take home and discuss with members of his family or support network. In addition to the tool 18 users may be provided with other take home items which may summarize the health information that they learned, for example but not limited to, wallet cards, cards, key chains, workbooks, mousepads, calendars, videos, compact discs, computer media and other things.

Through using the system of tool 18, cards 16 and conversation questions 7, users 14 may be guided through health information in a way that encourages, for example, learning and behavior change. Learning and behavior change may be achieved by, for example, pulling people out of ingrained thinking, challenging their notions, allowing them to digest information for themselves and come to their own conclusions, allowing them to identify their role in maintaining their own health and identifying how behavior choices affect health outcomes. A user session may conclude with the creation of a personalized “action plan.”

For illustration, the elements of an exemplary method, system and device are described below in FIGS. 2-6. The system is not limited to the following examples. Variations of the system and device are contemplated, for example, variations necessary to tailor the system to a multitude of health topics and health conditions, for example, but not limited to obesity, hemophilia, cancer, sexually transmitted diseases, asthma, depression, anxiety, heart disease, alcoholism, drug addiction, addiction, smoking cessation, HIV, AIDS, bariatric surgery (e.g., pre-operative and post operative), lung health, arthritis, cataracts, leukemia, gastric ulcers, blood conditions, heart conditions, gastrointestinal conditions, pediatric health conditions, birth defects, and other health related issues. Each health related issue may be further explored and tailored to different aspects of health care, (e.g., introducing insulin, diet, exercise, testing (e.g., episodic or continuous), complications, health maintenance and travel, new diagnosis, and etc.). Additionally, the tool may be targeted to various groups of individuals, for example, children, adults, retired individuals, ethnic groups (e.g., African American, Native American, Hispanic, Asian, and so on).

Although the system includes the following exemplary elements: facilitator 10, one or more users 14, an experiential learning tool 18, cards 16, conversation questions 7, and an action plan, other elements may be added to the system. Furthermore, the details of each basic element may vary based on the needs presented by the particular health topic covered. For example, the format of the tool (e.g., a map, blocks, puzzles, software, video, interactive web media, and etc.), the images and text imprinted on the tool, the number and use of the exercises (e.g., cards, blocks, puzzles, drawing, and etc.), the conversation questions, and the nature of the facilitator.

The following examples are non-limiting illustrations of how the system, method and device may be used to provide health information. Although the examples use a map as the experiential learning tool, the tool is not limited to a map. The tool may be manifest in many other formats as described above.

### EXAMPLE 1

The system, method, and device may be used to guide users 14 through information relating to type 2 diabetes. For example, a facilitator 10 may lead an individual user or a group of users 14 (hereinafter “users”) through information related to understanding type 2 diabetes. For example, early in their diagnosis, individuals, and/or their families, friends, support network, etc., may use the disclosed system, method and device either individually or in a group.

Generally, the method of conveying health related conversation may involve a facilitator 10 guiding users through health information represented on a experiential learning tool, which may be a map 18. The facilitator 10 may guide the users 14 through the information by asking a series of health-related conversation questions 7. Additionally, exercises, such as card exercises 16, may be utilized in combination with the tool 18 to engage the users in thought provoking exercises in behavior, attitude, or decisions related to type 2 diabetes.

A session may proceed as described below; however, the following example is merely illustrative and not limited to the details or to the particular health condition explored.

A user session may begin with an introduction. During the introduction the facilitator 10 may, for example: provide an overview of topics and introduce the map. For example, the facilitator may use the following questions to convey information and stimulate conversation. All dialogue provided is merely exemplary and not limiting. The quotation marks merely set off exemplary facilitator dialogue, map text, card text, and etc. Variations on the following are contemplated:
“During this session we'll be discussing type 2 diabetes. To have this discussion, we'll be using something called a Conversation Map™ (e.g., FIG. 2). The Conversation Map 100 is designed to engage a group of people in a conversation that is informative and meaningful to them. It will require participation and discussion, so you can learn from one another and make decisions that are going to help you better manage your diabetes. Of course, it's always important to discuss any changes you are going to make with your doctor, diabetes educator or other healthcare professional. With that, let's take a look at the different things we will discuss during this session. I will pass out a Conversation Topics Card (e.g., FIG. 3) to each one of you. The information on each of the cards 242 is the same. Would someone please read the information on this card 242 aloud? Are there any questions about the process you'll be going through or the topics you will be discussing?”

Referring now to FIG. 3, an exemplary representation of a conversation card 242, which may be used with the experiential learning tool (e.g., map) 100. The conversation card 242 may outline the topics that will be discussed. For example, but not limited to:
“Conversation Topics Card. Starting Your Journey with Type 2 Diabetes Conversation Map. Topics that will be discussed include: (1) My experience, understanding and feelings about type 2 diabetes; (2) What type 2 diabetes and blood glucose are; (3) Some of the common myths about type 2 diabetes; (4) What makes blood glucose go up and down and some of the signs and symptoms of high and low blood glucose; (5) The importance of testing blood glucose and when I should test; (6) Managing diabetes with nutrition and exercise.”

After each question, and at any other times, the users 14 may discuss topics related to the health condition elicited by the facilitator 10, experiential learning tool 18 (e.g., FIG. 2, 100), other users, or other sources. The conversation questions 7 may vary based on the circumstances, needs and experiences of the users.

The facilitator 10 may also ask the users 14 to describe the components of the tool 18 (e.g., FIG. 2, 100). Allowing users 14 to describe the tool 18 may help to orient them so that as they go through the session, they may be more familiar with where the information is represented.

Referring now to FIG. 2, an exemplary experiential learning tool 100, which may be map of any shape such as a rectangle, or alternatively, a square, circle, triangle, oval, star, or any other shape. The map may be imprinted with a scene which may be, for example, a town map. The map may alternatively be any scene. The scene may be a metaphor for progress, travel, growth, experience or learning, such as but not limited to, a street map, a building floor plan, a stream or river, a path through a forest, a waterfall, a growing plant, a farm, a city, tropics, an ocean, underwater, sailing, a domestic scene, travel, a shopping mall, a neighborhood, a town center, a school or college campus, a hospital, a library, a human body, an animal body, an organ or organs, or any other types of metaphors.

The map 100 may be a device for communicating health related information, for example, information targeted toward a user recently diagnosed with a health condition such as type 2 diabetes. For example, the map 100 may communicate health related information on a topic, such as but not limited to:
“Starting your journey with type 2 diabetes.” The map 100 may, alternatively, communicate health information targeted at different phases of health conditions, such as early diagnosis, continuing health maintenance, maintenance through diet, maintenance through exercise, maintenance through medication, late stage, getting back on track, etc. The tool 100 may address the health condition in a format that is relevant to users of different ethnicities, ages, socio-economic classes, literacy levels, and so on.

The experiential learning tool 18 may be a map. The map 100 may be broken into quadrants, for example, those represented by letters A-K in FIG. 2. The quadrants A-K may represent topic areas related to, for example, health, psychology, and lifestyle topics, among other things. The map 100 may include a path of travel 102 which may be a road. The path may alternatively be a hiking path, a river, a stream, a bridge, a ladder, or any other thing. The path of travel 102 may facilitate navigation of the health related topics, A-K, e.g., guiding the conversation between facilitator 10 and users 14.

The facilitator 10 may begin a session by directing the users' 14 attention to quadrant A of the map 100. Quadrant A may illustrate various ways individuals gather health related information. Individuals may gather information from, for example but not limited to, conversation with their family, friends, neighbors or others 112, 116. Alternatively, individuals may gather information from the media 114.

Individuals gathering information through conversation may be represented by individuals chatting 112, for example, but not limited to, an individual asking another “What do you know about diabetes?” Individuals gathering information may also be represented by individuals chatting on the sidewalk as in 116. For example, one individual relating to another, “This is what happened to me . . . ” Individuals may converse and obtain information from each other in other manners, therefore, the statements represented in 112 and 116 are merely non-limiting examples.

Individuals may also gather information through the media 114. This may be represented pictorially as in 114 by an individual watching a television. Alternatively, gathering health information through media may be represented by a person reading (e.g., a book, newspaper, magazine, etc.), using the computer technology (e.g., the internet, a computer disk, etc.), listening to a radio, or other means.

The facilitator 10 may ask the users 14 to discuss how they would describe type 2 diabetes in their own terms. This may provoke the users 14 to analyze the source of their beliefs about the health condition and, in a group setting, provide insight into the spectrum of beliefs, feelings, and notions about the condition. For example, the facilitator 10 may use conversation questions 7 to stimulate conversation, for example, by asking the following: “Each one of you comes to this session with a unique experience and understanding of diabetes. In your own words, how would you describe type 2 diabetes?”

The facilitator 10 may then refer users 14 to quadrant B. Quadrant B may illustrate for the users 14, for example, definitional or fundamental information about a health condition such as type 2 diabetes. Health information may be represented by, for example, a building 118, which may be labeled a “diabetes education center.” The inside of the building 118 may be visible. Individuals gathered around an instructor may be represented as in 120. A sign 122 may be positioned on the building 118. The sign may read, for example: “Diabetes Education. Type 2 diabetes is a lifelong disease that develops when your body does not respond well to insulin or produce enough insulin. Insulin is a hormone that helps glucose (also known as sugar) enter cells, where it is used for energy.”

The building may have a side wall 124. The side wall 124 may be imprinted with text, for example: “If the body becomes resistant to insulin, or the pancreas does not produce enough of it, your body cannot use glucose normally causing blood glucose to rise. When there is too much glucose in the blood over a period of time, the walls of the blood vessels are damaged which can cause problems with your eyes, heart, kidneys and nerves.” The health information may, alternatively, be illustrated in other ways.

The facilitator 10 may guide the users through the health related information in quadrant B of the map 100 as follows:
“Now let's look at some other basic definitions and information about type 2 diabetes. Locate the Diabetes Education building 118 on the left side of the Map 100. Can I have someone read the information on the sign 122 aloud and then read information on the side of the building 124? Is any of this information new to you or do you have any questions about it?”

The facilitator 10 may focus the users' 14 attention to quadrant C of the map 100. Quadrant C may represent emotional and psychological stages an individual might experience when they, a friend, or a family member is diagnosed with a health condition such as type 2 diabetes. For example, progression through emotional and/or psychological stages may be represented by a multi-floor building 126 (e.g., apartment building, hospital, hotel, etc.). Each floor 130, 132, 136, 138 of the building 126 may represent an emotional or psychological stage, for example, but not limited to, denial 130, anger 132, depression 134, bargaining 136, acceptance 138 or others.

The roof 128 may be imprinted with text which may set the context for conversation about the emotional or psychological stages represented, for example: “Are my emotions getting in the way of my ability to manage my diabetes.” Denial 130 may be represented pictorially by, for example but not limited to, an individual depositing an item, such as paper, into a garbage can. Anger 132 may be represented by, for example but not limited to, an individual with, for example, clinched fists, a furled brow, angry facial expressions, violent body positions, and etc. Depression 134 may be represented by, for example, but not limited to, a lethargic individual, such as an individual on a couch or bed. Bargaining 136 may be represented by, for example but not limited to, an individual in a resolute body position, for example, standing with hands on hips. Acceptance, 138 may be represented by an individual exiting the building 126, as a metaphor for, e.g., a person leaving behind the emotional or psychological stages.

In conjunction with the map 100, the facilitator 10 may guide the users 14 through an exploration of, for example, how the users' emotions affect their ability to manage their health condition. The facilitator may ask the users questions, for example, but not limited to:
“One of the real challenges of diabetes is dealing with the emotional side of the disease. Let's spend a moment discussing some of the feelings that can surround diabetes. Consider when you first found out you have diabetes: that is, when you were diagnosed with the disease. What was your reaction to the diagnosis and how did you feel? How do you fee about your diabetes today—right now? Most people, when they get what they perceive as bad news, go through a process leading up to acceptance. This process is depicted on the apartment building 126 on the left side of the Map 100. Let's discuss what each of the emotions in this process looks like, beginning with “Denial” 130. Why do you think it is important to get to the point of “Acceptance” 138 as it relates to managing diabetes? Since your diagnosis with diabetes, which of these emotions have you experienced and where do you think you are today? Dealing with the emotions that surround recently being diagnosed with a disease like diabetes can be a challenge. While the rest of this session does not focus on the emotional challenges of dealing with diabetes, you should speak to your doctor or diabetes educator if you feel as if you are stuck at any one of these emotional states.”

The facilitator may focus the user's attention quadrant D of the map 100. Quadrant D may represent the myths and truths surrounding a health condition, such as diabetes, through a scene. The scene may be, for example, a public park scene 140. The park scene 140 may be denoted by a sign 148. The sign 148 may read “The Park of Myths or Facts.” The scene 140 may be populated with park scenery such as trees, grass, etc. The scene may further include a feature 142, which may be a fountain. The feature 142 may be labeled, for example, “the fountain of truth.” The park scene 140 may be populated by a plurality of individuals 144. The individuals may be diverse, and may be, for example, individuals alone, in groups, and in conversation. The illustration of the individuals may include quote bubbles 146. The quote bubbles 146 may be inscribed with text, for example but not limited to: “how will we manage?”; “what should we do”; “did you know”; “ . . . diabetics can't . . . ”; “my cousin who has diabetes says . . . ”; “Test my blood glucose how often?”; “sugar does what?”; “That can't be true . . . ”; among other things.

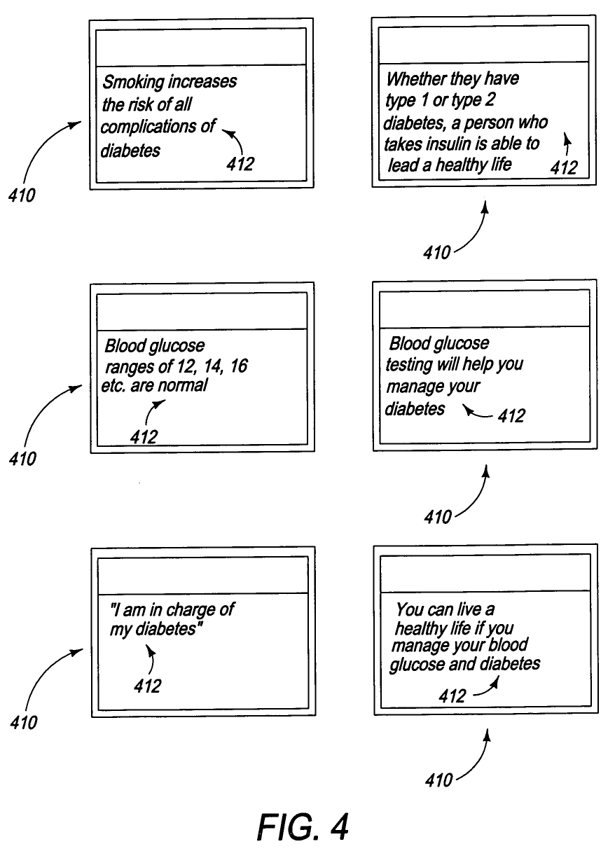

The facilitator may lead users through exercises identifying and addressing “myths” and “truths” related to a health condition as follows:
“Another real challenge about managing your diabetes is making sure you have the correct information about it. Let's take a look at some of the most common myths and some of the real facts about type 2 diabetes. I'm passing out the Myth or Fact Cards (e.g., FIG. 4, 342). On each of these cards there is a myth or a fact about type 2 diabetes. We'll go around the table and have each person read the information on his or her card one at a time. Then as a group, decide if that information is a true fact or a common myth about type 2 diabetes. We'll place the myths on the quote bubbles 146 in the park scene and the facts on The Fountain of Truth 142. Okay, please read our first card.”

Referring now to FIG. 4, an exemplary representation of “Myth or Fact Cards” 410 which may be used with the map 100. The cards 410 may each contain text 412, such as a different myth or fact about type 2 diabetes. The following list of statements is illustrative, but not limiting, of possible myth and fact statements 412:
“Eating sugar causes diabetes”; “Type 2 diabetes is more serious than type 1 diabetes”; “when people with type 2 diabetes begin insulin therapy, they are in the “final stages” of diabetes”; “I don't need to test my blood glucose at home—my doctor tests me”; “blood glucose ranges of 12, 14, 16, etc. are normal”; “I feel okay therefore I must be okay”; “white bread is bad for you”; “foods specifically marketed to people with diabetes have many special benefits”; “blood glucose testing will help you manage your diabetes”; “whether they have type 1 or type 2 diabetes, a person who takes insulin is able to lead a healthy life”; “natural sugar has the same impact on blood glucose as processed sugar”; “your body needs carbohydrates for energy”; “you can live a healthy life if you manage your blood glucose and diabetes”; “diabetes should prevent you from doing what you want”; “I am in charge of my diabetes”; “smoking increases all complications of diabetes.”

The facilitator 10 may conclude the exercise with follow up questions, for example:
“Have you heard any other common myths about type 2 diabetes that weren't listed on one of the myth cards? Where are some of the most common places people hear these myths or get their misinformation?”

The facilitator 10 may focus the users' 14 attention to region E of the map 100 which may represent, for example, the basics about blood glucose. Quadrant E may represent, for example, information about blood glucose, through a scene. Quadrant E may be, for example, a gas station scene 150. The scene may depict, for example, a gas station 171, individuals 160, 162 filling automobiles 152, 154 with fuel from fuel pumps 156, 158. One individual 160 may be filling an automobile 152 which may be labeled “normal.” A second individual 162 may be filling an automobile 154 which may be labeled “diabetes.” There may be a fuel spill 164 from the individual 162 fueling the “diabetes” automobile 154.

Information about, for example, blood glucose, may be communicated by the metaphor of the gas scene 150. Information may further be communicated through text inscribed on the gas scene 150. For example, a sign 170 on the gas station 171 may be inscribed with “Blood Glucose Station (also known as blood sugar).” A front wall or window 172 of the gas station 171 may be inscribed with information about blood glucose, for example, but not limited to: “Blood glucose is simply the amount of glucose, also known as sugar, in your blood. Everyone has glucose in their blood. Glucose is used to fuel most of your body's functions. You get glucose from food. Your liver also produces it. Blood glucose tends to go up and down throughout the day depending on what activity you are doing and what you have been eating.”

The gas pumps 156, 158 may be inscribed with text, for example, but not limited to, blood glucose levels. For example, gas pump 156 fueling the “normal” automobile 152 may be inscribed with “Normal Blood Glucose Before Meals 4.0-6.0 mmol/L After Meals 5.0-8.0 mmol/L.” The gas pump 158 fueling the “diabetes” car 154 may includes an exploded view 166 which may be inscribed with “Blood Glucose Targets Before Meals 4.0-7.0 mmol/L 2 Hours After Meals 5.0-10.0 mmol/L.” Numbers and units may change to reflect the units recognized by the region in which the map is released, for example, in the United States, average glucose may be expressed in “mg/dL” (e.g., 7 mmol/L (SI units) may be expressed as 126 mg/dL (US units)).

The road 102 near the gas scene 150 may be inscribed with text. The text 168 may be, for example, “Note: Treatment goals must be tailored to the individual. Ask your physician or diabetes educator if these targets are appropriate for you.”

In conjunction with quadrant E of the map 100, the users 14 may be asked to discuss the information provided in the gas station metaphor. The facilitator 10 may lead users 14 through health related information related to, for example, the basics about blood glucose as follows:
“One of the most important concepts related to understanding and managing your diabetes is understanding blood glucose, also known as blood sugar. Let's take a look at some information about blood glucose. Can I have a volunteer read the information on the Blood Glucose Station 172 and the gas pump 160, 162? Focus on the images representing blood glucose. Why do you think the concept of blood glucose was visualized in this way (e.g., a filling station 171, overflowing fuel 164)? As we said earlier, diabetes affects each person in different ways. So it is important to remember treatment goals like blood glucose targets must be tailored to the individual by discussing them with your physician or diabetes educator.

The facilitator may focus the user's attention to quadrant F which may represent, for example, things that affect blood glucose. This information may be represented, for example, as a residential block. The block may have a plurality of buildings 176 which may be, but are not limited to, houses, businesses, or any other buildings. The block may be bordered by a sidewalk 178. The scene 174 may represent factors affecting for example, blood glucose which may include but are not limited to medication 180, illness 182, stress 184, nutrition 186, alcohol 188, exercise and activity 190, and other things.

Medication 180 may be represented by, for example, an individual investigating a medicine cabinet. Illness 182 may be represented by, for example, an individual in bed. Stress 184 may be represented by, for example, an individual operating a computer, the individual expressing stressful facial expressions and body position. Nutrition 186 may be represented by, for example, an individual eating snack food, an individual investigating a refrigerator, a group of individuals dining at a table, and other things. Alcohol 188 may be represented by, for example, an individual or individuals consuming a beer, martini, or other alcoholic drink. Exercise and activity 190 may be represented by individuals performing yard work, walking, or other things. A task list for blood glucose management may be represented by an individual with a writing instrument and a writing pad 192. The writing pad may contain text such as a task list, such as, but not limited to, “(1) Track my blood glucose results (2) look for patterns (3) discuss appropriate changes with my health care team (4) reassess by testing my blood glucose.”

The users 14 may also see representations of symptoms on the map 100. The symptoms, for example, changes in blood glucose level (e.g., high blood glucose or low blood glucose), may be represented on the sidewalk 178 bordering the scene 174. The symptoms 194 may include but are not limited to: fatigue, blurred vision, thirst, headaches, frequent urination, mood swings, shakiness, sweats, headaches, fast heart beat, mood swings, irritability, hunger, nausea, confusion, and other symptoms

In conjunction with quadrant F, the facilitator 10 may use conversation questions 7 to guide users' 14 conversation for example, but not limited to, the following manner:
“So now that we've talked about what blood glucose is and general target ranges, let's discuss the things that can make your blood glucose to up and down. Some of these things are depicted across the center of the Map F. They include illness, medication, stress, nutrition, alcohol and exercise & activity (180, 182, 184, 186, 188, 190). Does anyone know what it's called when blood glucose is high? How about when blood glucose is low?”

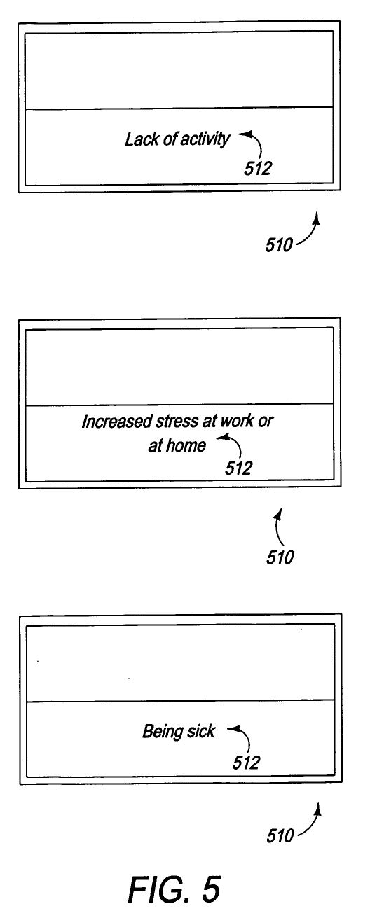

“Okay, now let's look at some of the things that will make your blood glucose go up and down. I'm passing out The Causes of High & Low Blood Glucose Cards. (e.g., FIG. 5) Read what's on your card 510 one at a time and match it to the image across the center the Map F to which it best pertains. Then as a group, decide if what's on the card would make your blood glucose go up or down. Who wants to start?”

FIG. 5 represents another possible type of card 510 that may be used with the map 100. Cards 510 may be inscribed with text 512, such as various causes of either high or low blood glucose. The text 512 may include but are not limited to the following:
“Eating too much food”; “Lack of activity”; “Forgetting to take diabetes medication”; “Being sick”; “Increased stress at work or at home”; “More physical activity than usual”; “A late or skipped meal or eating less than usual”; “Taking more diabetes medication than usual”; “drinking alcohol without eating if you are on diabetes medication”; and other things.

The facilitator 10 may conclude the exercise by asking the users 14 the following questions:
“Why is it important to know what can make your blood glucose go up and down?
Next, let's take a look aft some of the signs and symptoms of high and low blood glucose. Could I have a volunteer read the information across the sidewalk 194 near the bottom of the Map 100? Have any of you had some of these signs and symptoms before? What has your personal experience been with recognizing certain signs and symptoms associated with having high or low blood glucose?
While you will sometimes be able to recognize these signs and symptoms, sometimes your blood glucose will be out of range and you will not be able to feel it. That's why frequent testing is so important to managing your diabetes.”

The facilitator 10 may direct the users' 14 attention to quadrant G of the map 100. Quadrant G may represent for the users 14 the importance of testing blood glucose. For example, a newspaper truck 228 may be inscribed with text related to the importance of testing. The text may include, but is not limited to: “Why I Should Test. Testing your blood glucose will help you determine: how daily choices about food, activity and exercise affect your diabetes; how other things like stress and illness affect your diabetes; how to make changes to help your blood glucose stay on target.” A news paper 230, for example, may be inscribed with text related to when testing should be performed. The text may include, but is not limited to: “When I should Test. Test around the events that affect your blood glucose the most like meals, medications, stress, exercise and activity. Testing should be done at various times of the day: Testing before meals and 2 hours after meals will let you know the effect of your meal; Testing before, during and many hours after exercise will let you know how the activity affected your blood glucose. More frequent testing may be required to make adjustments to daily activity, food intake and medication.”

In conjunction with quadrant G, the facilitator 10 may lead users 14 through information related to, for example, the importance of testing blood glucose as follows:
Let's talk some more about the importance of testing your blood glucose. Can I have a volunteer read the information entitled Why I should Test G on the truck 228 and When I Should Test on the newspaper 229 in the lower left corner of the map? 100”

The facilitator may lead users through health related information related to, for example, managing blood glucose with diet, by focusing the users' 14 attention on quadrants H of the map 100. Quadrant H may represent for the users 14, for example, suggested nutritional element portion sized for diabetes management. The topic of diabetes management through nutrition may be represented by, for example, a diner or restaurant scene.

The scene may include a building 196 which may be a diner, and a plurality of portion representations 200, 202, 204, 206, 208, which may be hands, and a circle 198 which may be a plate or dish 198. The dish 198 may illustrate with divisions and/or text a manner of estimating proper proportions of various food items by eyeing them. For example, proper portions for managing diabetes may include, half of the plate 198 devoted to vegetables, one-fourth of the plate 198 devoted to starch, one fourth of the plate 198 devoted to protein. The plate 198 may be inscribed with text, for example, but not limited to: “Vegetables (at least 2 kinds); Starch (potato, rice, pasta); Protein (fish, lean, meat, chicken, beans, lentils).”

A second manner of representing suggested serving sizes of various nutritional elements may also be illustrated by a hand metaphor. For example, vegetable portions 200 may be represented by two hands, for example, suggesting two handfuls of vegetables. Carbohydrate portions 202 may be represented by a fist, for example, suggesting a fist sized portion of carbohydrates. Fruits 204 may be represented by a fist, for example, suggesting a fist sized portion of fruits. Protein 206 may be represented by a palm, for example, suggesting a palm sized portion of protein. Fat 208 may be represented by a thumb-tip, for example, suggesting a thumb-tip sized portion of fat.

Information about, for example, managing diabetes with nutrition, may be shown such as inscribed on a wall 210 of the building 196. The inscription may be, for example, but not limited to: “Contain Carbohydrates (raise blood glucose): grains, fruit, milk and yogurt, jams, jellies, sugar and other sweets. Contain little or no carbohydrates: vegetables, meat and alternatives, fats.”

The scene may also contain text 212 that states the following: “Meal Spacing Basics. Eat three meals a day four to six hours apart. You may benefit from healthy snacks between meals and at bedtime.”

The facilitator 10 may lead a discussion of managing diabetes by diet, for example, as follows:
“Nutrition and exercise are two important aspects of managing your blood glucose levels and your diabetes. First, let's talk about nutrition by looking at those foods that contain carbohydrates and those that have little to no carbohydrates. Can I have a volunteer read the information on the Windows 210 of the restaurant 196 in the upper right the map? Why is this information important to you and anyone with diabetes? So now you know which foods contain carbohydrates and cause your blood glucose to go up, and those foods that contain little or no carbohydrates.”

In conjunction with quadrant H, the facilitator 10 may guide the users 14 through an exercise as follows:
“Now let's take a look at a couple of basic strategies for getting the right amount of food to keep your blood glucose levels in your target range. I want each of you to take a piece of paper and draw a large circle on it. The circle on it will represent a plate 198. Consider your typical main meal (e.g., supper). Divide the circle into 3 “slices” representing the amount of vegetables, starches and proteins you eat at that meal. Now compare your picture to the recommended “plate” 198 that represents healthy eating in the upper right of the Map 100. As you can see this plate is divided into ½ for vegetables, ¼ for starches and ¼ for proteins. This will give you a well-balanced meal. And you can add milk and a fruit for dessert. How did your plate compare? What does this tell you?”

“There are some other basic recommendations each of us can follow to ensure we are getting reasonable and healthy portions of different food groups at each meal. Let's take a look at these recommendations. Can I have someone describe the five hand images 200, 202, 204, 206, 208 in the upper right of the Map 100? Are you getting the right portions of different types of foods? Are you eating too much or too little of any types of foods? Another important aspect of managing your diabetes and controlling your blood glucose is how often and when you are eating. Could I have a volunteer read the information entitled Meal Spacing Basics 212 located on the sidewalk in the upper right of the Map? Why do you think this information is important to managing your diabetes and controlling your blood glucose? What types of things have you tried when it comes to nutrition that you have found effective at helping you control your blood glucose and your diabetes? Does anyone have any specific questions related to food and nutrition?

The facilitator may guide the users through health-related information, for example, controlling blood glucose through exercise and activity by directing their attention to quadrant I. Quadrant I may represent a scene for the users 14, for example, a house scene 214, representing various methods of maintaining diabetes with exercise and activity. The scene may have a house 216 and a yard 218. Exercise and activity may be represented by individuals variously engaged. For example, but not limited to, individuals strength training 222, individuals on a tread mill 224, individuals doing yard work 226, and other things.

The scene 214 may also include information about exercise and activity recommendations. The recommendations may be represented by, for example, but not limited to, text on the yard 218. The text may include, but is not limited to, “Recommendation: At least 150 minutes a week. For example: 15 minutes, 2 times a day, 5 days a week; 30 minutes, 5 days a week; 50 minutes, 3 days a week. There are many kinds of activities you can do: walking swimming, riding a bicycle, dancing, raking leaves, etc. Anything that gets your muscles moving and circulation going! You should do some strength training at least 3 times a week. Start slowing at first and gradually increase.”

In conjunction with quadrant I, the facilitator may employ the following dialogue:
“Another key aspect of managing your diabetes is being active and getting enough exercise. Exercise and activity will lower your blood glucose and can also improve your heart health, strengthen your bones and enhance your general well being. Let's take a look at some of the basic recommendations about exercise and activity. Can I have a volunteer read the information in the upper right of Map entitled Exercise and Activity Recommendations 218? It is recommended that you exercise at moderate intensity. Can someone explain what they think “moderate intensity” means? What types of things have you tried when it comes to exercise and activity that you have found effective at helping you control your blood glucose and manage your diabetes? Does anyone have any specific questions related to exercise and activity? Of course, medication is another tool for helping you control your blood glucose. Your doctor will work with you to determine when medication might be right for you and what medication options exist today.”

The facilitator 10 may focus the users' 14 attention on quadrants J and K. Quadrant J may provide a guide for developing an action plan. The numbers 232-236 may illustrate various parts of an action plan. For example, but not limited to, My Goal 232, My Measures of Success 233, Challenges I will Overcome 234, My Support Network 235, Achieving My Goal 236.

Quadrant K may provide a representation of aids to achieving a goal of diabetes management. This may include, but is not limited to, a support network 238 and resources 240. The support network may include, but is not limited to, representations of individuals who may be family, friends, coworkers, and healthcare team. Resources 240 may include but are not limited to web sites. The web sites may include, but are not limited to those related to diabetes, nutrition, exercise, health, etc.

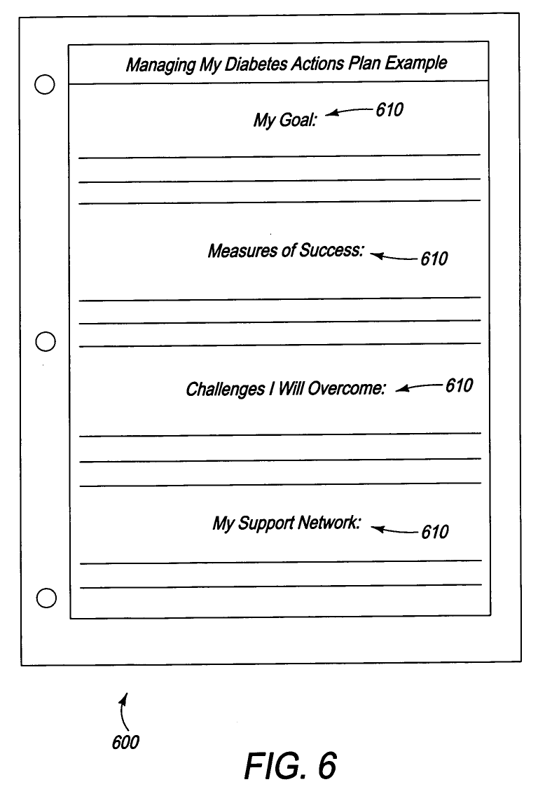

FIG. 6 is an exemplary representation of a form 600 which may be included in the system. The form may be an “Action Plan” which may have fields 610 for the users to fill in based on conclusions the users may have reached during their experience of the system and method. The fields 610 may include, but are not limited to, the following: “My Goal: What is one thing I could try to do better to manage my blood glucose and diabetes?”; “Measures of Success: What will change when I achieve my goal? What are the benefits of achieving my goal?”; “Challenges I will Overcome: What challenges might I face in achieving my goal? What do I need to do to overcome these challenges?”; “My Support Network: What help will I need from my Support Network to accomplish my goal?”

The facilitator may lead users through health related information related to, quadrants J and K, and creating an action plan 600 as follows: “One of the goals of this session is to have each of you determine one thing you can do differently to better manage your diabetes. We will spend the remainder of the session working on this. Let me show you an example of what we will be doing. Now please get the Managing My Diabetes Action Plan (e.g., FIG. 6) and consider what you discussed and learned during the session. What is one new or different thing you could do to better manage your blood glucose and diabetes? Make sure you fill out each area 610 on your action plan 600. I will give you a few minutes to do this. Is anyone willing to share their goal with the rest of the group?

“To accomplish your goal you will probably need the support of those around you—your support network. These people are depicted in the lower right corner of the Map K. Who is, or could be, a part of your support network 238? How can your support 238 network help you achieve your goal? You may also need more information to achieve your goal. Some resources 240 you might turn to are listed on the computer screen in the bottom right corner of the Map. Can someone read this list of resources 240 aloud for the group? What other resources 240 have you found to be helpful in your personal experience?”

The facilitator may conclude the session as follows:
“Take a moment to think about everything you discussed during this session. What did you learn about diabetes, about yourself and about any changes you can make to help you better manage your diabetes?

Thank you very much for your participation. I hope you learned something and feel more in control of your diabetes. And again, please remember to discuss any changes you are going to make with your doctor, diabetes educator or other healthcare professional.”

Example 2 further illustrates the breadth of the method utilizing the system and device. The example is merely illustrative of one of various manners the method, system, and device may be utilized. It is not limiting. The facilitator may use different conversation questions 7, may proceed through the material in a different order, and may make other variations. The basic method illustrates a non-limiting manner of using facilitated conversation to lead users through health related information by utilizing an experiential learning tool (e.g., map) and exercises.

### EXAMPLE 2

The system, method, and device may be used to guide users through information relating to type 2 diabetes. For example, a facilitator 10 may lead users 14 through information related to understanding type 2 diabetes or health maintenance with type 2 diabetes represented on an experiential learning tool 18, which may be a map 702.

The facilitator 10 may guide users 14 through the information by asking a series of health-related conversation questions 7. Additionally, exercises, such as card exercises, may be utilized in combination with the map. The exercises may engage the users in thought provoking explorations of behavior, attitude, or decisions related to type 2 diabetes. The user session may cover topics related to type 2 diabetes. There are numerous topics which may be discussed, the following list of possible topics is merely illustrative and not limiting: the natural progression of type 2 diabetes; A1C and how it can be used to better manage diabetes; various medications used for controlling blood glucose and diabetes; managing diabetes with nutrition and exercise; possible consequences of not managing diabetes; improved diabetes management. Topics such as those listed may be, for example, covered in one session, or each topic may be the focus of one system, method and device.

A session may proceed as described below; however, the following example is merely illustrative and not limited to the details or to the particular health condition explored. A user session may begin with an introduction, for example, the following:
“During this session we'll be discussing type 2 diabetes. To have this discussion, we'll be using something called a Conversation Map™ (e.g., FIG. 7, 702). The Conversation Map 702 is designed to engage a group of people in a conversation that is informative and meaningful to them. It will require participation and discussion from you, so that you can learn from one another and make decisions that are going to help you better manage your diabetes. Of course, it's always important to discuss any changes you are going to make with your doctor, diabetes educator or other healthcare professional.”

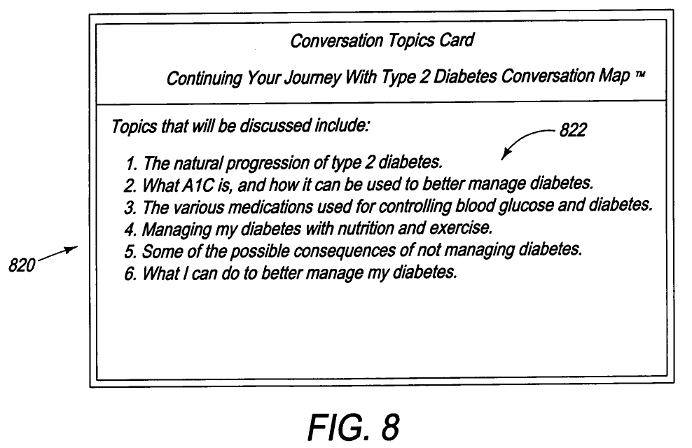

“With that, let's take a look at the different things we will discuss during this session. I will pass out a Conversation Topics Card (e.g., FIG. 8, 820) to each one of you. The information on each of the cards 820 is the same. Would someone please read the information on this card aloud? Are there any questions about the process you'll be going through or the topics you will be discussing?”

Referring now to FIG. 8, an exemplary representation of a conversation card 820. The conversation card 820 may be used during the introduction phase of the Health Conversation and may outline the topics that will be discussed. Text 822 may be printed on the card, for example, but not limited to:

“Conversation Topics Card. Continuing Your Journey with Type 2 Diabetes Conversation Map. Topics that will be discussed include: (1) The natural progression of type 2 diabetes; (2) What A1C is, and how it can be used to better manage diabetes; (3) The various medications used for controlling blood glucose and diabetes; (4) Managing my diabetes with nutrition and exercise, (5) Some of the possible consequences of not managing diabetes; (6) What I can do to better manage my diabetes.”

The facilitator 10 may then direct the users' 14 attention to a map such as FIG. 7, 702. FIG. 7. shows an exemplary experiential learning tool, which may be a map 702. If the tool is a map, the map may be a rectangle or alternatively, a square, circle, triangle, oval, star, or any other shape. The map 702 may be imprinted with a scene which may be, for example, a wilderness map. The map may alternatively be any scene that may, for example, be a metaphor for progress, travel, growth, experience or learning, as discussed above in Example 1.

The experiential learning tool 702 may be, for example, a map, for communicating health related information, such as but not limited to: “Continuing your journey with type 2 diabetes.” The tool 702 may, alternatively, communicate health information targeted at different phases of health conditions, such as early diagnosis, continuing health maintenance, maintenance through diet, maintenance through exercise, maintenance through medication, late stage, getting back on track, etc.

The tool may be a map. The map may be broken into quadrants, for example, those represented by letters M-S. The quadrants may represent topic areas related to, for example, health, psychology, and lifestyle topics, among other things. The map, may include a path of travel 703 which may be a hiking path. The path 703 may alternatively be a hiking path, a river, a stream, a bridge, a ladder, or any other thing. The path of travel 703 may facilitate navigation of the health related topics, M-S.

The facilitator 10 may introduce users 14 to the map 702 as follows:
“Okay, now let's take a minute to explore the Conversation Map that is on the table in front of you. I will hold the Map. As a group, describe what you see.”

The facilitator 10 may invite the users 14 to describe their diabetes experience by asking, for example:
“How long ago were you diagnosed with type 2 diabetes? Has your diabetes been the same since diagnosis or have you seen any changes? As you know, diabetes is a lifelong disease and as we age, our bodies change and it often becomes more difficult to keep your blood glucose within your target range. Have any of your found this to be the case?”

The facilitator 10 may then direct users' 14 attention to quadrant M of the map 702. Quadrant M may provide a representation of, for example but not limited to, signs and symptoms of poor diabetes management. The representation may include, for example, a cliff 706. Various individuals, 708, 710, 712 may be gathered around the cliff 706. The individuals may be costumed to represent a park ranger 708 (e.g., wearing a ranger outfit), a health care worker 710 (e.g., in a white lab coat holding a clip board, etc.), and an individual 712 (e.g. dressed in casual wear). The individual 712 may be a diabetic individual, and may be variously represented, for example, as male, female, young, or old, and any of various racial or ethnicities.

Information on the topic of being “off target” may be represented by text inscribed on the cliff 706. The text may include, but is not limited to the following: “Signs and Symptoms of Being Off Target. Low Blood Glucose: Shakiness, sweats, headaches, mood swings, irritable, fast heartbeat, hunger, nausea, confusion. High Blood Glucose: fatigue, blurry vision, thirst, frequent urination, mood swings, headaches.”

The scene may also include various trail signs 704, 711. The trail signs may be inscribed with text, for example but not limited to “start here” 704 (e.g., to direct user's attention to the region which may be the starting point of the conversation); “Is my diabetes getting worse? How can I tell?” 711 (e.g., eliciting conversation on analyzing current state of diabetes management, etc.).

The region between Quadrant M and Quadrant N may include a representation 714 of an individual 712, which may be a diabetic, getting back on the “trail” of diabetes management. The metaphor 714 may be accomplished by, for example, an illustration of an individual 712 dropping sweet foods and sodas and bush wacking the overgrowth that obscures the trail 703.

In conjunction with quadrant M the facilitator 10 may use conversation questions 7 to guide the users 14 through conversation as follows: “We are starting our session today in the lower left of the Map M. Let's “walk up the trail”. What are some of the ways you can tell you are getting off track when it comes to managing your diabetes? What might cause you to get off track? Measuring your blood glucose and observing patterns in response is one way you can tell if you are getting off track. And some people experience certain signs and symptoms when their blood glucose is out of its target range. Let's take a look at some of these signs and symptoms. Can I have a volunteer read the information on the cliffs 706 on the left side of the Map 702? While you might experience some of these signs and symptoms when your blood glucose is too high or too low, sometimes your blood glucose will be out of range and you will not feel it. Frequently testing your blood glucose is the best way to know if your levels are too high or too low.”

Discussing and assessing the user's personal experience with the health related condition may make the users more open to information about how to better maintain their health status by, for example, monitoring their health state. For example, the discussion of signs and symptoms that indicate that a diabetic is off track may make users open to a discussion of the importance of monitoring blood glucose levels.

The facilitator 10 may focus users' 14 attention on quadrant N. Quadrant N may provide a representation of, for example but not limited to, information related to diabetes testing. The scene in Quadrant N may include, but is not limited to, a cabin 722, an individual 712 examining a compass, a rock 716, a trail side sign 720, a chart 718, and other things.

The scene N may educate users about diabetes testing through, for example, illustrations and text. For example, the rock 716 may be inscribed with information including but not limited to: “A1C Definition: A1C is a measure of your average blood glucose for the past 3 months. The A1C test should be done about every 3 months.” The cabin 722 may be inscribed, for example but not limited to, on the sides, roof, or other location. The text may be, but is not limited to, “When I Should Test. Test around the events that affect your blood sugar the most like meals, medications, stress, exercise and activity.”; “Testing should be done at various times of the day: testing before meals and 2 hours after meals will let you know the effect of your meal; testing before, during and many hours after exercise will let you know how the activity affected your blood. More frequent testing may be required to make adjustments to daily activity, food intake and medication.”; “Why I should test. Testing your blood glucose will help you determine: how daily choices about food, activity and exercise affect your diabetes; how other things like stress, illness, etc., affect your diabetes; how to make changes to help keep your blood glucose on target.”; “Blood Glucose Targets. Before Meals 4.0-7.0 mmol/L 2 Hours After Meals 5.0-10.0 mmol/L.” Numbers and units may change to reflect the units recognized by the region in which the map is released.

Information about, for example, A1C target ranges may represented. For example, but not limited to, in the format of a chart 718 which may be positioned on the trail 703 or any other place. Numbers and units may change to reflect the units recognized by the region in which the map is released, for example, in the United States, average glucose may be expressed in “mg/dL” (e.g., 7.5 mmol/L (SI units) may be expressed as 135 mg/dL (US units). The chart 718 may include the following information:

A1C Target Range

| | | Average blood glucose |
|---|---|---|
| A1C | | mmol/L |
| 6% | Target | 7.5 |
| 7% | Range | 9.5 |
| 8% | | 11.5 |
| 9% | | 13.5 |
| 10% | | 15.5 |

Information about, for example, why A1C testing alone is not enough for diabetes management, may be represented. For example, but not limited to, a trail side sign 720 which may display a chart representing A1C and blood glucose data of two or more hypothetical individuals. The sign 720 may illustrate the blood glucose cycles of two individuals 719, 720 over several days. Both individuals may have an A1C score of, for example, but not limited to, 7% and an average blood glucose level of for example, 9.5 mmol/L. One individual 719 may show steady blood glucose, closely approximating, for example, 9.5 mmol/L over the course of days (e.g., blood glucose level falling between˜8 mmol/L and ˜11 mmol/L). The second individual 721 may show unsteady blood glucose levels over the course of days (e.g., blood glucose levels falling between ˜5 mmol/L and ˜12 mmol/L on any given day).

In conjunction with quadrant N, the facilitator 10 may lead users 14 through health related information related to the importance of testing as follows:
“As diabetes progresses you will probably need to test more frequently to manage your blood glucose levels. Let's take a look at when and why you should test your blood glucose. Can I have someone read the information on the cabin 722 near the bottom of the Map 702? How many people are currently testing their blood glucose? How often are you testing your blood glucose? When are you testing?
How are you keeping track of your results? In your opinion, what are the benefits of keeping track of your results? Keeping track of your results will allow you to observe patterns over time and enable you to better manage your diabetes.”

“Something else that can help you determine how well you have been managing your diabetes is called the A1C test. Let's take a look at what A1C is 716. Can I have a volunteer to read the definition of A1C on the rock 716 and the A1C Target Range information on the trail 718 on the left side of the Map 702? Do you have any questions about what A1C is? The A1C test can be very useful test but you also need to continue to test your blood glucose on a daily basis —let's look at why. Locate the chart entitled Why A1C Isn't Enough 720 near the center of the Map 720. How would you describe what's happening on these charts 719, 721? If each of the two charts 719, 721 represented a different person with type 2 diabetes which one do you think would be feeling better 719, 721? How many of you know your last A1C? Has knowing your A1C helped you better manage your diabetes? If yes, how? So again, while the A1C test gives you an overall reading that can be very useful, you also need to be measuring and monitoring your blood glucose on a more frequent basis. Because while your A1C may be in an acceptable range, your blood glucose may be swinging from too high to too low. Therefore, A1C alone does not give you the detail you need to make day to day decisions about managing your blood glucose. Only frequent blood glucose testing can do that.”

The facilitator 10 may direct users 14 to quadrant O on the map 702. Quadrant O may represent information, for example, information about diabetes management through medication, for example, but not limited to, through a series of scenes. The scenes may include, but are not limited to: a scene illustrating oral medications 726, for example, in which an individual 728 may be investigating a plurality of, for example, trail side signs 730, 732, 734, 736; a scene which may illustrate insulin injections 742, which may include information about, for example, bolus insulin 738 and basal insulin 740; a scene which may illustrate an individual interacting with a health care worker 744.

A scene may represent information about, for example, oral medications 726. For example, but not limited to, a scene of an individual 728 investigating multiple trail side signs 730, 732, 734, 736. The road side signs 730, 732, 734, 736, may for example, be inscribed with images, such as images of pills. The road side signs 730, 732, 734, 736, may for example, be inscribed with text, such as text related to activities of medication.

For example, a trail side sign, 730, may illustrate a plurality of pills. The sign 730 may further include text, for example, but not limited to: “Stimulate your pancreas to release more insulin.” A trail side sign, 732, may illustrate a plurality of pills. The sign 732 may further include text, for example, but not limited to: “Slow the liver from producing glucose and cause the cells to be a little more sensitive to insulin.” A trail side sign, 734, may illustrate a plurality of pills. The sign 734 may further include text, for example, but not limited to: “Cause liver cells to be more sensitive to insulin.” A trail side sign, 736, may illustrate a plurality of pills. The sign 736 may further include text, for example, but not limited to: “Slow the absorption of glucose from the intestine thereby slowing the rise in blood glucose after meals.” The information may be adapted to medications and actions not listed, as well as conditions not listed.

Information about, for example but not limited to, insulin treatment, may also be represented. For example, an insulin user 742 may be represented by an individual with a hypodermic needle. Information about insulin therapy may be represented, for example, by a series of mountains 738, 740, which may be inscribed with text. The text on a mountain 738 may be, but is not limited to: “Bolus insulin (or pre-meal insulin) is short acting and is taken before meals to offset the rapid increase in blood glucose caused by the meal. There are different types of bolus insulin, some faster acting than others.” The text on a second mountain 740 may be, but is not limited to: “Basal insulin is usually taken once or twice a day and is meant to provide a consistent amount of insulin throughout the day unrelated to meals. There are also different kinds of basal insulin, some intermediate acting and some longer acting.”

Information about, for example, insulin therapy, may be represented. For example, but not limited to, a scene which may be a scene of an individual interacting with a health care worker 744. The scene may include text, for example, but not limited to: “Note: Type and amount used will be determined on an individual basis.”

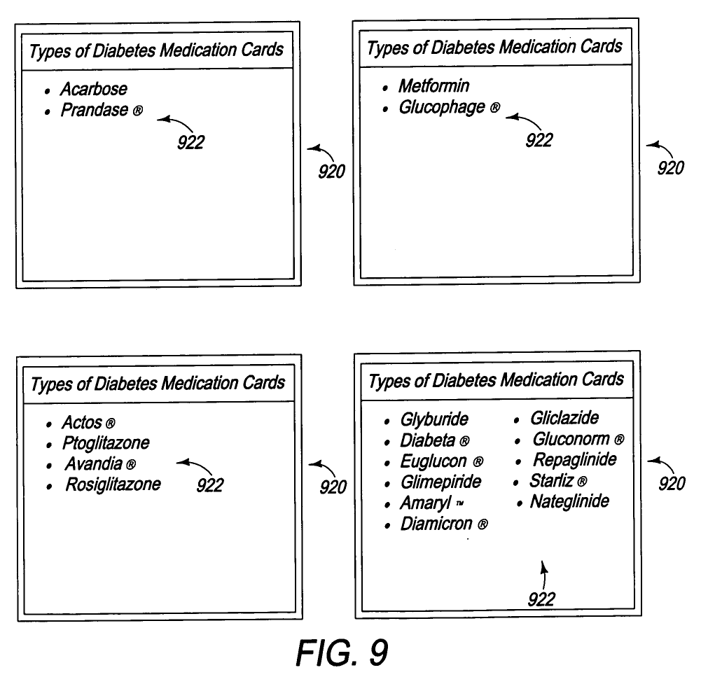

The facilitator 10 may encourage the users 14 to relate their experience with diabetes medications by asking questions such as but not limited to: “When diet and exercise are not enough to control your diabetes, your doctor may prescribe oral medications. Let's take a look at some of the different types of pills that are available today for controlling diabetes. Could I have someone read the information on the signs 730, 732, 734, 736 in the upper left of the Map about how the different types of oral medications affect your body? Now let's look at some of the specific brands of diabetes medications available today and what actions they have. I am passing out the Types of Diabetes Medications Cards (e.g., FIG. 9). On each of these cards there is a list of some diabetes medications available today. I'll have each of you read aloud the medications listed on the card. Then as a group, decide which card matches each type of diabetes medication listed on the signs 730, 732, 734, 736 at the top of the Map 720 and place the card there. Does anyone have any questions about these medications or the actions they have on the body? Of course, it's important to remember that none of these pills are insulin, and no medication can cure diabetes.”

Referring now to FIG. 9, is an exemplary representation of cards, for example but not limited to, “Types of Diabetes Medication Cards” that may be used with the map 702, as described above. The cards 920 may each contain one or a plurality of medication brand names 922, organized together, for example, by medication activity. The following list of medication brand names is illustrative, but not limiting: Glyburide, Gliclazide, Diabeta, Gluconorm, Euglucon, Repaglinide, Glimepiride, Starlix, Amaryl, Nateglinide, Diamicron; Metformin, Glucophage; Actos, Pioglitazone, Avandia, Rosiglitazone; Acarbose, Prandase, and others.

The facilitator 10 may use conversation questions 7 to continue to guide users 14 in conversation as follows:
“Are any of your currently taking one or more of these pills to help you better control your blood glucose (e.g., FIG. 9)? Can you describe your results and experiences using them? It's important to remember that adhering to your prescription when it comes to diabetes medications is critical to their effectiveness. If your blood glucose continues to be off target because your pancreas stops making enough insulin, your doctor may prescribe insulin therapy. There are several different types of insulin available today, but they fall into one or two categories. Would some be will to read the different types of insulin listed on the hills 738, 740 in the upper left of the Map 702? Are any of you taking insulin? What has your experience been with being prescribed insulin, taking it and monitoring your blood glucose in response to it? In conclusion of this section about medications, and as a reminder, the type and amount of medication used will always be determined on an individual basis.”

The facilitator may focus users' attention on region P of the map 702. Quadrant P may represent health information about managing diabetes through nutrition. Information may be represented, for example, by a series of scenes which may be scenes related to camping activities. The scenes may include, but are not limited to: a camp site scene 746; a dining area scene 754; a fishing scene 772; various peripheral scenes 768, 777, 779, 781, 783, and scenes, images and etc. Information about diabetes management through nutrition may include, but is not limited to, information about carbohydrates. Information about carbohydrates may be represented, for example, but not limited to, through a camp site scene 746; peripheral scenes 768, 777, 779, 781, 783, and others.

A camp site scene 746 may include users cooking over a campfire, camping tents 748, 750 and other things. The image of individuals cooking may provide a reference for where users can focus their attention. Information, for example, about carbohydrates may be communicated textually, for example, inscribed on a wall of a tent 748, 750. For example, a tent 748 may be inscribed with: “Contain carbohydrates (raise blood glucose) grains and starches, fruit, milk and yogurt, jams, jellies, sugars, and other sweets.” A second tent 750 may be inscribed with, for example but not limited to: “Contain little or no carbohydrates: vegetables, meat and alternatives, fats.”

The topic of diabetes management through nutrition may be represented by, for example, a campsite dining scene 754. The scene may include a dining table 756 which may be a tree stump, a plurality of portion seats around the table represented by rocks 758, 760, 762, 764, 766. The rocks may be inscribed with, for example, images of hands 758, 760, 762, 764, 766, and which may illustrate suggested portion sizes.

The tree stump table 756 may include an image of a circle 757 which may be a plate or dish. The dish 757 may illustrate to users, with divisions and/or text, a manner of estimating proper proportions of various food items by eyeing them. For example, proper portions for managing diabetes may include, half of the plate 757 devoted to vegetables, one-fourth of the plate 757 devoted to starch, one fourth of the plate 757 devoted to protein. The plate 757 may be inscribed with, for example, but not limited to: “Vegetables (at least 2 kinds) Starch (potato, rice, pasta) Protein (fish, lean, meat, chicken, beans, lentils).”

A second manner of representing suggested serving sizes of various nutritional elements may be illustrated by a hand metaphor. For example, vegetable portions 766 may be represented by two hands, for example, suggesting two handfuls of vegetables. Carbohydrate portions 764 may be represented by a fist, for example, suggesting a fist sized portion of carbohydrates. Fruits 762 may be represented by a fist, for example, suggesting a fist sized portion of fruits. Protein 760 may be represented by a palm, for example, suggesting a palm sized portion of protein. Fat 758 may be represented by a thumb-tip, for example, suggesting a thumb-tip sized portion of fat.

The facilitator 10 may ask the users 14 questions about how the information represented on the map 702 relates personally users by asking questions exemplified, but not limited to, the following:
“Nutrition and exercise are two important aspects of managing your diabetes. First, let's talk about nutrition by looking at those foods that contain carbohydrates and those that have little to no carbohydrates. Can I have a volunteer read the information on the tents 748, 750 in the middle of the Map 720? Why is this information important to you and anyone with diabetes?”

“So now you know which goods contain carbohydrates and cause your blood glucose to go up, and those foods that contain little or no carbohydrates. Now let's take a look at a couple of basic strategies for getting the right amount of food to keep your blood glucose in your target range. I want each of you to take a piece of paper and draw a large circle on it. The circle on it will represent a plate. Consider your typical main meal (e.g., supper). Divide the circle into 3 “slices” representing the amount of vegetables, starches and proteins you eat at that meal. Now compare your picture to the recommended “plate” 757 on the large tree stump 756 that represents healthy eating in the upper right of the Map 702. As you can see this plate 757 is divided into ½ for vegetables, ¼ for starches and ¼ for proteins. This will give you a well-balanced meal. And you can add milk and a fruit for dessert. How did your plate compare? What does this tell you? There are some other basic recommendations each of us can follow to ensure we are getting reasonable and healthy portions of different food groups at each meal. Let's take a look at these recommendations. Can I have someone describe the information on the five hand images on the rocks 754, 758, 760, 762, 764, 766 in the upper right of the Map 702?

Information about, for example, carbohydrates, may include peripheral scenes 768, 777, 779, 781, 783. For example, information on carbohydrate examples 768, may be represented. For example, but not limited to a scene in which a ranger may be pointing out information on carbohydrate examples 768 which may be inscribed on the trail 703. Text on the trail may include, but is not limited to, the following:

Carbohydrate Examples

| Grains and starches = | | Milk and alternative = |
|---|---|---|
| 15 grams | Fruits = 15 grams | 15 grams |
| 1 slice whole wheat bread | 1 medium apple | 1 cup of milk |
| ⅓ cup of cooked rice | 1 small banana | ¾ cup plain yogurt |
| ½ medium potato | ½ cup of juice | |

Information on suggested total carbohydrates at lunch 777, may be represented. For example, but not limited to a scene in which a ranger may be pointing out information on carbohydrate examples 777 which may be inscribed on a tree stump. The information may be illustrated in other ways, such as through different meal choices, the following is only an example. Text on the stump may include, but is not limited to, the following:

| | | |
|---|---|---|
| 1 ham sandwich, 2 slices of bread | 30 | g |
| Lettuce/tomato | 0 | g |
| ¾ cup plain yogurt | 15 | g |
| 1 medium pear | 15 | g |
| 1 cup water or sugar free tea | 0 | g |
| Total grams of carbs | =60 | g |

For example, information on suggested total carbohydrates per meal 779, may be represented. For example, but not limited to a scene which may include a trail side sign inscribed with information 779. The information may be illustrated in other ways; the following is only an example. Text on the sign may include, but is not limited to, the following:

An Example of the Number of Carbohydrates Per Meal

| Meal | Grams of Carbohydrates |
|---|---|
| Breakfast | 45–60 grams |
| Lunch | 60–75 grams |
| Supper | 60–75 grams |
| Snacks | 0–15 grams |

For example, information on how to count carbohydrates 781, may be represented. For example, but not limited to a scene which may include a river bank 781 inscribed with information. The information may be represented in other ways; the following is only an example. Text on the river bank 781 may include, but is not limited to, the following:
“Carb Counting Basics. Some people learn to measure the amount they eat by counting the amount of carbohydrates (carbs) in each meal. This is where a dietitian can help you. He or she can tell you exactly how many carbs you should eat at each meal.”

Other peripheral items, such as but not limited to greenery 783, for example, in the shape of “15,” may help the users remember critical health related information.

Other nutrition information may also be represented. For example, but not limited to a scene 770 which may include an individual fishing 772 in a river 774. The information may be represented in other ways; the following is only an example. Text inscribed on the river may include, but is not limited to, the following:
“A Heart Healthy Diet (for both high blood pressure and cholesterol) includes: Following a diet lower in saturated fat and cholesterol (these include animal fats and hydrogenated fats); Eating more fiber (about 25 grams per day) which is found in whole grains, fruits and vegetables; Eating lots of fruits and vegetables (at least 5-10 servings per day); Incorporating nuts and seeds into your diet (about two tablespoons fiver times per week); Using low fat dairy products; limiting salt use (add no salt at the table); Limiting alcohol if blood pressure is high.”

The facilitator 10 may guide users 14 through further information related to controlling diabetes with diet as follows: “What types of things have you tried when it comes to nutrition that you have found effective at helping you control your blood glucose and your diabetes? There are a couple more advanced nutrition strategies for managing your diabetes that we will explore. They are carbohydrate counting and heart healthy diet. Let's first discuss counting. Could I have a volunteer read the information entitled Carb Counting Basics listed on the hill 781 on the right side of the Map 702? Carb counting typically involves counting carbs in 15 gram increments. Let's take a look at some examples of types and amounts of food that contain approximately 15 grams of carbohydrates. Could I have another volunteer read the Carb Examples 768 on the path? Finally, let's take a look at an example of what a typical meal might include and how many grams of carbs you might want tot target at each meal. To do this could I have someone read all the information on the sign entitled An Example of the Number of Carbs Per Meal 779 and the Lunch 777 example on the tree stump on the right side of Map 702? Has anyone here tried carb counting? What has your experience been? Now let's talk about another nutrition strategy—a heart healthy diet. This type of diet can help you reduce your risk of heart disease, which can be very important for those with type 2 diabetes. Could I have a volunteer read aloud the information about the heart healthy diet in the lake 774 on the right side of the Map 702? Why is it important for people with type 2 diabetes to improve their heart health? Has anyone here tried any of these heart healthy diet recommendations? What has your experience been? Does anyone have any specific questions related to food and nutrition?”

The facilitator 10 may focus users' 14 attention to quadrant Q. Quadrant Q may provide information about managing diabetes through activity and exercise. Information may be represented, for example, by a series of scenes which may be scenes illustrating individuals engaged in activities 785, 786, 787, 788. Activities and exercises are not limited to those represented, the examples are merely illustrative and not limiting. Exemplary activities and exercises may be, for example: raking 785, operating exercise equipment 786, dancing 787, strength training 788, and other exercises and activities.

Information on exercise and activity recommendations may be represented. For example, but not limited to a scene which may include information 891 inscribed on the trail 803. The information may be represented in other ways; the following is only an example. Text 891 on the trail 803 may include, but is not limited to, the following:
“Exercise and Activity Recommendations. Recommendation: At least 150 minutes a week. For example: 15 minutes, 2 times a day, 5 days a week; 30 minutes, 5 days a week; 50 minutes, 3 days a week. There are many kinds of activities you can do: walking swimming, riding a bicycle, dancing, raking leaves, etc. Anything that gets your muscles moving and circulation going! You should do some strength training at least 3 times a week. Start slowing at first and gradually increase.”

The facilitator 10 may assist users 14 to discuss their current ideas, beliefs, and practices related to exercise. The facilitator 10 may encourage the users 14 to analyze how, for example, current ideas, beliefs, and practices assist or hinder type 2 diabetes management. The facilitator 10 may lead users 14 through health related information related to, for example, managing diabetes with exercise and activity, as follows:
“Okay, now let's talk about another way of managing your diabetes —exercise and activity. Let's start by taking a look at some of the basic recommendations about exercise and activity. Can I have a volunteer read the information in the lower right of the Map entitled Exercise & Activity Recommendations 791? It is recommended that you exercise at moderate intensity. Can someone explain what they think “moderate intensity” means? What types of things have you tried when it comes to exercise and activity that you have found effective at helping you control your blood glucose and manage your diabetes? Does anyone have any specific questions related to exercise and activity?

The facilitator 10 may focus users' 14 attention to quadrant R. Quadrant R may represent, for example but not limited to, information about consequences of not managing diabetes. The scene may include, but is not limited to: a danger zone, which may include a ravine 796. The path to the ravine 796 may be pictorially represented as a downward spiral. The danger of the ravine 796 may be illustrated by, for example, a ranger 793 suggesting an individual turn back, a caution sign 797 or other ways.

Health information may be communicated in the scene R. For example, the ravine 796 may include textual representations of various organs which may be affected by poor diabetes management 799. Although the organs are represented textually, they may be represented pictorially or otherwise. Organs affected 799, may be, but are not limited to, eyes, heart, kidneys, and nerves.

In conjunction with quadrant R the facilitator 10 may guide users 14 through information, for example, about the possible consequences of not managing their diabetes as follows:
“Not managing blood glucose levels can damage your body over time. Specifically it can cause damage to the walls of your blood vessels. What organs in your body can be impacted by diabetes? So many complications that can arise from not managing diabetes usually impact the eyes, heart, kidneys and nerves—these organs are listed in the center of the map 799. What specific types of complications are you aware of? Not properly managing your diabetes over time can cause damage to the nerves, heart disease, poor circulation leading to foot problems, damage to the retina in eyes, sexual dysfunction, and damage to the kidneys. But if you control your blood glucose levels these complications can be delayed or even prevented. Even with good management of your diabetes, it is important to know about various tests that can lead to early detection of many of these complications. Early diagnosis can lead to more effective treatment.”

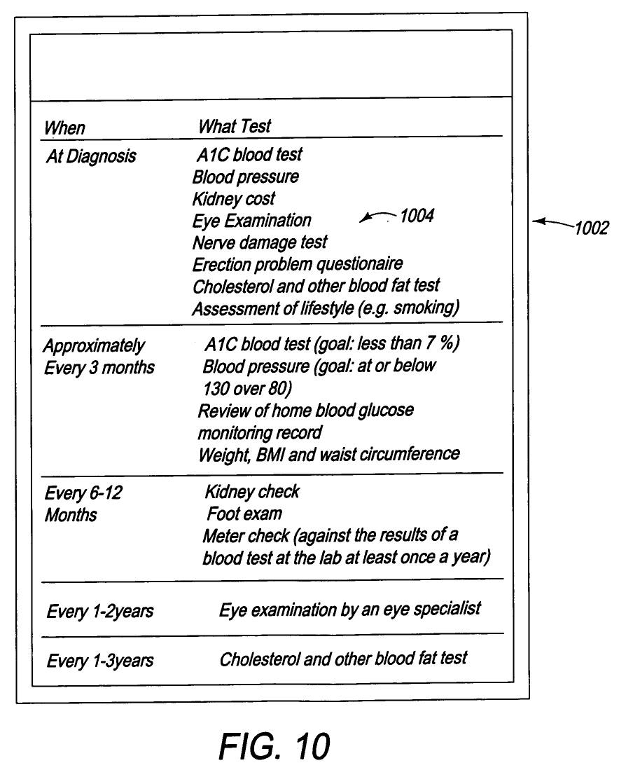

The facilitator may utilize the following exercise to provoke thought and deepen learning by engaging the users. The example is not limiting. “Let's take a look at some of these tests. I am passing out the Screening for Complications Cards (e.g., FIG. 10). All the information on these cards 1002 is the same. Could I have a volunteer read the information on this card aloud for the group? What complications have you been screened for—what tests have you had done? How can you ensure that you are getting screened and that any complications you might have are detected early?”

FIG. 10 is an exemplary representation of cards, for example, “Screening for Complications Card” 1002. The cards 1002 may contain information 1004 in the form of text or otherwise about, for example, type 2 diabetes screening. The following is illustrative, but not limiting, of possible textual content 1004:

Screening for Complications Card

| When | What Test |
|---|---|
| At Diagnosis | A1C Blood Test |
| | Blood pressure |
| | Kidney Test |
| | Eye Examination |
| | Nerve damage test |
| | Erection problem questionnaire |
| | Cholesterol and other blood fat test |
| | Assessment of lifestyle (e.g., smoking) |
| Approximately Every 3 Months | A1C Blood Test (goal: less than 7%) |
| | Blood pressure (goal: at or below 130 |
| | over 80) |
| | Review of home blood glucose |
| | monitoring record |
| | Weight, BMI and waist circumference |
| Every 6–12 Months | Kidney check |
| | Foot check |
| | Meter check (against the results of a |
| | blood test at the lab at least once a year) |
| Every 1–2 Years | Eye Examination by an eye exam |
| | specialist |
| Every 1–3 Years | Cholesterol and other body fat test |

The facilitator 10 may focus users' 14 attention to quadrant S of the map 702. Quadrant S may provide a visual guide for developing an action plan and identifying the user's support network. Number 802 may illustrate a scene pictorially representing individuals creating an action plan. The action plan 802 may include, for example, but not limited to, “My Goal,” “My Measures of Success,” “Challenges I will Overcome,” “My Support Network,” “Achieving My Goal.”

Quadrant S may further provide a representation of aids to achieving a goal of diabetes management. This may include, but is not limited to, a support network 803, and resources 808. Rangers on a search tower 804 may be used to illustrate identifying the users support network, other metaphors may also be used. The search tower 804 may include text relating to potential members of the user's support network, for example, but not limited to: “Family, friends, coworkers, and healthcare team.” The support network 803 may include, but is not limited to, representations of individuals who may be family, friends, coworkers, a healthcare team, and others. A metaphor of using a computer to find resources may be used 806. However, other methods of finding resources may be illustrated. Resources 808 may include but are not limited to web sites. The web sites may include, but are not limited to those related to diabetes, nutrition, exercise, health, etc.

The facilitator 10 may lead users 14 through health related information related to, for example, identifying acts that the users may take to improve health condition management as follows:
“One of the goals of this session is have each of you determine one thing you can do differently to better manage your diabetes. We will spend the remainder of the session working on this. Let me show you an example of what we will be doing. (stop and do) Now I will distribute Managing My Diabetes Action Plan (e.g., FIG. 6) to each one of you. Consider what you learned during the session. What is one new or different thing you could do to better manage your blood glucose and diabetes? Make sure you fill out each area on your action plan. I will give you a moment to do this. Is anyone willing to share their goal with the rest of the group? To accomplish your goal you will probably need the support of those around you—your support network. In the Map, they are represented as park rangers 804. Who is, or could be, a part of your support network? How can your support network help you achieve your goal? You may also need more information to achieve your goal. Some resources you might turn to are listed near the bottom of the Map 808. Can someone read this list of resources aloud for the group? What other resources have you found to be helpful in your personal experience?

The facilitator 10 may conclude a user 14 session as follows: “Take a moment to think about everything you discussed during the session. What did you learn about diabetes, about yourself and about any changes you can make to help you better manage your diabetes? Thank you very much for your participation. I hope you learned something and feel more in control of your diabetes. And again, please remember to discuss any changes you are going to make with your doctor, diabetes educator or other healthcare professional.”

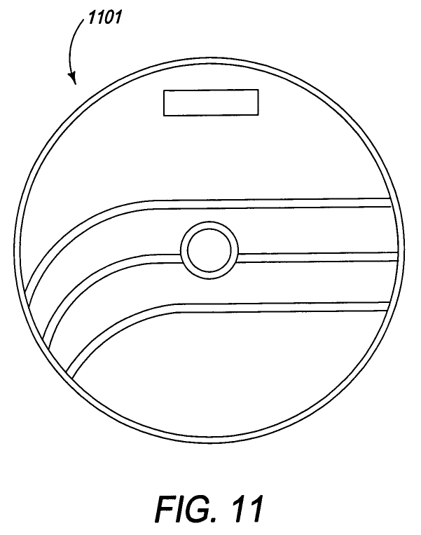

FIG. 11 is an exemplary representation of media 1101. The media 1101 may be a DVD, CD Rom, Tape, Record, VHS, or any other form of media that transmits information such as sound and or visual. The media 1101 may contain information, for example, but not limited to, instructions for use of the system, facilitator training, an example of use of the system, or other information.

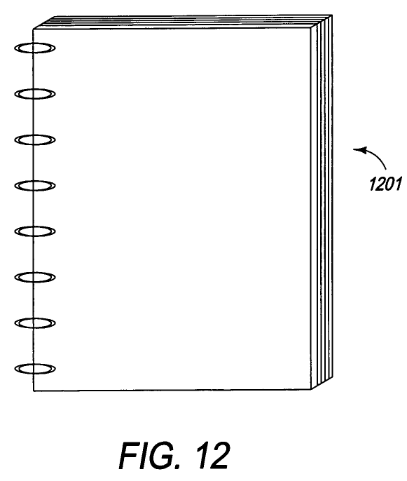

FIG. 12 is an exemplary representation of an manual or guide 1201 of the system 8. The guide 1201 may be a facilitator guide. The guide 1201 may include suggested conversation questions 7 for the facilitator 10 to use to lead the conversation and navigate the users through the experiential learning tool 702. The guide 1201 may be a binder into which the various components of the system may be stored. For example, a three ring binder, a bag adapted to fit a three ring binder for holding the conversation cards, an envelope for holding the media, multiple “take home” copies of the experiential learning tool 702, multiple copies of the “action plan,” among other things.

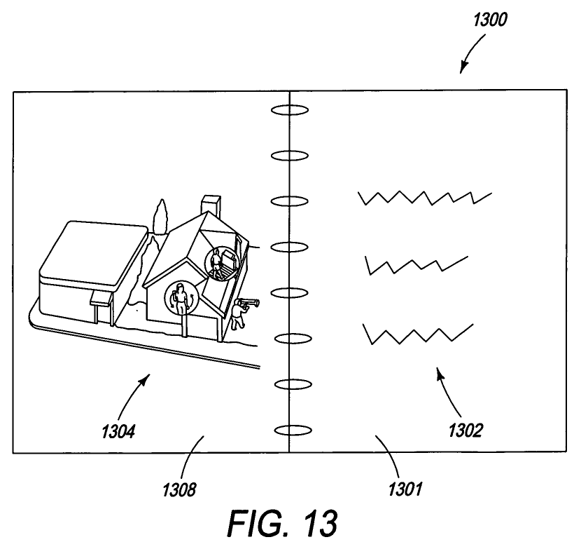

FIG. 13 is an exemplary view of an experiential learning tool 1300 in a book format. The tool 1300 may have an image 1304 on a first page 1303 and text 1302 on a second page 1301. The first page 1303 may be a page facing the second page 1301. The image 1304 may be, for example, a portion or quadrant of an experiential learning tool 18, such as a map (e.g. 100, 702). The text 1302 may be, for example, the conversation questions 7, relevant to the image 1304. The experiential tool may be dimensioned for use at a pharmacy, school, home, book store, retail store, and etc.

While various embodiments of the system have been described, it will be apparent to those of ordinary skill in the art that many more embodiments and implementations are possible that are within the scope of the system.

We claim:

1. A method for delivering health information to a user, wherein a facilitator elicits conversation from a user, the method comprising:
providing an experiential learning tool;
introducing the user to topics related to a health condition presented by the experiential learning tool; and
eliciting discussion on the health topic represented on the experiential learning tool by asking conversation questions.

2. The method of claim 1 further comprising eliciting discussion on the health topic using exercises.

3. The method of claim 1 wherein the health topic is selected from the group consisting of obesity, hemophilia, cancer, sexually transmitted diseases, asthma, depression, anxiety, heart disease, alcoholism, drug addiction, addiction, lung health, arthritis, cataracts, leukemia, gastric ulcers, blood conditions, birth defects, pediatric health conditions, preoperative bariatric surgery, post operative bariatric surgery, HIV, AIDS, metabolic syndrome and smoking cessation.

4. The method of claim 1 wherein the health condition is diabetes.

5. The method of claim 4 wherein an exercise comprises distinguishing myths about diabetes from truths about diabetes.

6. The method of claim 4 wherein an exercise comprises recognizing high or low blood glucose affectors and analyzing whether the affector raises or lowers blood glucose.

7. The method of claim 4 wherein an exercise comprises the user drawing a representation of the user's typical serving from good groups including protein, starch, and vegetable and comparing the drawing to recommendations portrayed on the experiential learning tool.

8. The method of claim 4 further comprising the users creating an action plan based on the experience in which the user identifies health related goals.

9. A method of encouraging behavior change in patients comprising:
providing an experiential learning tool which presents information and topics related to a health condition and illustrates the affects of behavioral choices on the health of the patient; wherein, when combined with a facilitator, conversation questions, and exercises, the patient explores the health condition and learns how to manage the condition both mentally and physically.

10. The method of claim 9 wherein the health topic is selected from the group consisting of obesity, hemophilia, cancer, sexually transmitted diseases, asthma, depression, anxiety, heart disease, alcoholism, drug addiction, addiction, lung health, arthritis, cataracts, leukemia, gastric ulcers, blood conditions, birth defects, pediatric health conditions, preoperative bariatric surgery, post operative bariatric surgery, HIV, AIDS, metabolic syndrome and smoking cessation.

11. The method of claim 9 wherein the health condition is diabetes.

12. The method of claim 11 wherein an exercise comprises distinguishing myths about diabetes from truths about diabetes, wherein the user analyzes statements about a blood glucose affector and analyzes whether the affector raises or lowers blood glucose.

13. The method of claim 11 wherein an exercise comprises recognizing high or low blood glucose affectors and analyzing whether the affector raises or lowers blood glucose.

14. The method of claim 11 wherein an exercise comprises the user drawing a representation of the user's typical serving from good groups including protein, starch, and vegetable and comparing the drawing to recommendations portrayed on the experiential learning tool.

15. The method of claim 11 further comprising the users creating an action plan based on the experience in which the user identifies health related goals.

16. A system for delivering health information to a user the system comprising:
an experiential learning tool;
a facilitator guiding conversation and movement through the experiential learning tool; and
exercises to educate.

17. The system of claim 16 wherein the exercises are selected from the group consisting of cards, puzzles, drawing and blocks.

18. The system of claim 16 wherein the health topic is selected from the group consisting of obesity, hemophilia, cancer, sexually transmitted diseases, asthma, depression, anxiety, heart disease, alcoholism, drug addiction, addiction, lung health, arthritis, cataracts, leukemia, gastric ulcers, blood conditions, birth defects, pediatric health conditions, preoperative bariatric surgery, post operative bariatric surgery, HIV, AIDS, metabolic syndrome and smoking cessation.

19. The system of claim 16 further comprising a plurality of cards imprinted with statements or images pertaining to facts about diabetes.

20. The system of claim 16 further comprising a plurality of cards imprinted with statements or images pertaining to myths about diabetes.

21. The system of claim 16 further comprising cards imprinted with statements pertaining to the causes of low blood glucose.

22. The system of claim 16 wherein a plurality of cards are blank to allow the user to include their own statements relating to diabetes health goals, measures of success, challenges, and support network.

23. The system of claim 16 wherein the experiential learning tool is a map comprising a metaphor of a city map through which the user explores topics related to their health condition.

24. An experiential learning tool for delivering health information to a user, said tool comprising:
a plurality of scenes imparting health related information; and
a facilitator to guide movement through the health related topics imparted on the tool.

25. The tool of claim 24 wherein the health information is selected from the group consisting of obesity, hemophilia, cancer, sexually transmitted diseases, asthma, depression, anxiety, heart disease, alcoholism, drug addiction, addiction, lung health, arthritis, cataracts, leukemia, gastric ulcers, blood conditions, birth defects, pediatric health conditions, preoperative bariatric surgery, post operative bariatric surgery, HIV, AIDS, metabolic syndrome and smoking cessation.

26. An experiential learning tool for delivering health information to a user in a map format, said tool comprising:
a start area, an end area, and a plurality of locations between defining a conversation path and wherein the locations are metaphors for various issues related to diabetes.

27. The tool of claim 24 wherein the health information is selected from the group consisting of obesity, hemophilia, cancer, sexually transmitted diseases, asthma, depression, anxiety, heart disease, alcoholism, drug addiction, addiction, lung health, arthritis, cataracts, leukemia, gastric ulcers, blood conditions, birth defects, pediatric health conditions, preoperative bariatric surgery, post operative bariatric surgery, HIV, AIDS, metabolic syndrome and smoking cessation.

28. The tool of claim 24 wherein the health information is diabetes.

29. The tool of claim 28 wherein the issues represented on the map comprise:
a user's experience, understanding and feelings about type 2 diabetes;
a description of type 2 diabetes and blood glucose;
common myths about type 2 diabetes;
blood glucose affectors;
signs and symptoms of high and low blood glucose;
an importance of testing blood glucose and when a user should test; and
managing diabetes with nutrition and exercise.

30. The tool according to claim 29 wherein the representation of a user's experience and feelings about type 2 diabetes comprises:
a representation of a building;
the building divided into multiple floors;
each floor representing an emotional or psychological state; and
each emotional or psychological state represented pictorially or textually.

31. The tool according to claim 29 further comprising a representation of what type 2 diabetes and blood glucose are, the representation comprising:
a building;
a class and an instructor inside the building; and
text on a side of the building defining diabetes and blood glucose.

32. The tool according to claim 29 further comprising a scene including:
a park;
a plurality of individuals within the park;
the individuals engaged in conversation; and
a fountain within the park.

33. The tool according to claim 29 further comprising a representation imparting information about blood glucose levels, the representation comprising:
a gas station;
fuel tanks associated with the gas station;
individuals fueling their automobiles associated with the gas station; and
text imparting information about blood glucose levels.

34. The tool according to claim 29 further comprising a representation imparting information about blood glucose affectors, the representation comprising a plurality of individuals engaged in activities that may raise or lower blood glucose.

35. The tool according to claim 29 further comprising a representation imparting information about the signs and symptoms of high and low blood glucose, the representation comprising:
a sidewalk; and
a textual representations of signs and symptoms of high and low blood glucose inscribed upon the sidewalk.

36. The tool according to claim 29 further comprising a representation imparting information about the importance of testing and when the user should test, the representation comprising:
a news paper van;
a news paper associated with the news paper van; and
text related to the importance of testing and when the user should test inscribed upon the pictorial.

37. The tool according to claim 29 further comprising a representation of information about managing diabetes with diet, the representation comprising:
a diner;
a plate divided into three sections representing suggested portions of starch, protein and vegetable;
images of a plurality of hands in various postures;
a first image of two open hands;
a second image of a fist;
a third image of a palm;
a fourth image of a thumb; and
text inscribed upon the representation imparting information relating to managing diabetes with nutrition.

38. The tool according to claim 29 further comprising a representation imparting information about managing diabetes with exercise, the representation comprising:
a house;
a yard adjacent to the house;
a plurality of individuals within and outside the house;
the individuals engaged in activities;
the activities including strength training, operating exercise equipment, and operating a lawn mower.

39. The tool according to claim 38, wherein the representation of managing diabetes with exercise further comprises a plurality of suggestions relating to duration and frequency of healthy activities.

40. The tool according to claim 29, further comprising a representation of the means for improving diabetes management, the representation comprising:
a plurality of individuals gathered around a computer;
an exploded view of the computer screen; and
internet web site addresses inscribed upon the computer screen.
